(19) United States
(12) Patent Application Publication
(10) Pub. No.: US 2004/0119333 A1
(43) Pub. Date: Jun. 24, 2004

(54) Device for controlling brakes in a commercial vehicle

(76) Inventor: Thomas Hackl, Eberdingen (DE)

Correspondence Address: CROWELL & MORING LLP, INTELLECTUAL PROPERTY GROUP, P.O. BOX 14300, WASHINGTON, DC, 20044-4300, US

(21) Appl. No.: 10/631,004

(22) Filed: Jul. 31, 2003

(30) Foreign Application Priority Data
Aug. 2, 2002 (DE) 102 35 472.3

(51) Int. Cl. B60T 8/32; G05D 1/00

(52) U.S. Cl. 303/125; 303/191; 303/167; 701/96; 701/301

(57) ABSTRACT

A device and method for controlling the brakes of a commercial vehicle are provided and include a device for the adaptive regulation of distance and/or driving speed (ACC), which modulates an urgency signal (d) based upon a hazard variable such as the relative speed of and/or distance to a vehicle traveling in front of said commercial vehicle, an electronically controlled brake system, which is designed to distribute a desired amount of braking force to a friction brake system and a retarding brake, and wherein the electronically controlled brake system is further designed in such a way that the distribution of the desired braking force to the friction brake system and the retarding brake is also based upon the urgency signal (d).

### BACKGROUND AND SUMMARY OF THE INVENTION

The invention relates to a device for controlling the brakes of a commercial vehicle.

From the state of the art, for example from German patent document DE 199 10 590 A1, a system that will allow the adaptive regulation of the distance and/or driving speed of a vehicle, a so-called adaptive cruise control (ACC) system, is known, wherein the system modulates an urgency signal that is based upon a hazard variable, for example the relative speed of and/or the distance to a vehicle traveling in front of said vehicle, and if necessary initiates braking.

Further, electronically controlled brake systems (EBS) for commercial vehicles are known, which are designed to distribute the braking force desired by the driver to a friction brake and an additional retarding brake. In this type of system, the friction brake most often takes the form of a pneumatic brake, and the additional retarding brake takes the form of an engine brake or a retarder. The goal is to generate the amount of braking force desired by the driver while keeping wear and tear on the friction brakes at a minimum. To this end, efforts are made to apply the very quick response pneumatic friction brakes only initially when the brakes are applied, replacing them later with the delayed braking force of the retarding brake. The transfer from the friction brake to the retarding brake is referred to as “blending”. The distribution of braking force between the friction and retarding brakes is thus time-dependent. In addition to the functions related to the distribution of braking force to the friction and retarding brakes, additional regulating functions are integrated into the EBS, such as slip regulated brakes or a load-dependent braking force distribution.

The object of the present invention is to further develop a system for controlling the brakes of a commercial vehicle in such a way that the scope of its functions can be expanded, and that it can be produced more easily and cost-effectively.

This object is attained according to the invention by providing a system for controlling the brakes of a commercial vehicle, comprising the following: a) a device for the adaptive regulation of distance and/or driving speed (ACC), which modulates an urgency signal (d) based upon a hazard variable such as the relative speed of and/or distance to a vehicle traveling in front of said commercial vehicle; b) an electronically controlled brake system, which is designed to distribute a desired amount of braking force to a friction brake system and a retarding brake; and c) the electronically controlled brake system is further designed such that the distribution of the desired braking force to the friction brake system and the retarding brake is also based upon the urgency signal (d).

In an advantageous manner, the function of distributing braking force to the friction brake and the retarding brake, which is already integrated into the electronically regulated braking system, is also used to effect an allocation of braking force based upon the urgency signal that is modulated by the ACC system. This dual use of the EBS control system allows a very simple design for the brake system. Specifically, the need to equip the ACC system with its own function of distributing braking force to the friction brake and the retarding brake can be eliminated. Furthermore, because the braking torque generated by the retarding brake is monitored by the electronically regulated brake system in any case, the system can apply the friction brake if the retarding brake does not provide sufficient braking power.

The characterizing features disclosed in the dependent claims provide advantageous further developments of and improvements on the invention.

According to an especially preferred design of the invention, a value range for the urgency signal between 0% indicating no urgency and 100% indicating the greatest urgency is provided.

According to one further development, a control device for the electronically controlled brake system is designed such that at high urgency values, the desired braking force is distributed to the friction brake and the retarding brake to achieve the fastest possible application of the brakes, while at low urgency values, the retarding brake is used to its maximum extent in order to reduce wear and tear on the friction brake. Under this premise, in time-critical or urgent situations having high urgency values (urgency value close to or at 100%), for example, if a vehicle should suddenly dart onto the roadway from a side street while the commercial vehicle is traveling downhill, the fastest possible application of the required braking force is distributed to the friction brakes and the retarding brakes. In contrast, with the priority of reducing wear and tear on the friction brakes, only the retarding brake is applied when a very low urgency value is present (urgency value close to or at 0%), for example, if a vehicle in front of the commercial vehicle is driving at a relatively great distance and at a somewhat slower speed. The transition between these extreme values is smooth, i.e. the distribution of braking force to the friction brake and the retarding brake is variably applied based upon the urgency value.

In a particularly preferred manner, a CAN bus is provided for transmitting the urgency signal from a control device of the system for the adaptive regulation of distance and/or driving speed to the control device of the electronically regulated brake system. The urgency signal is represented, for example, by a signal based upon the SAE J1939 Standard.

Other objects, advantages and novel features of the present invention will become apparent from the following detailed description of the invention when considered in conjunction with the accompanying drawings.

### BRIEF DESCRIPTION OF THE DRAWINGS

FIG. 1 schematically illustrates a preferred design of a device for controlling the brakes of a commercial vehicle.

### DETAILED DESCRIPTION OF THE DRAWINGS

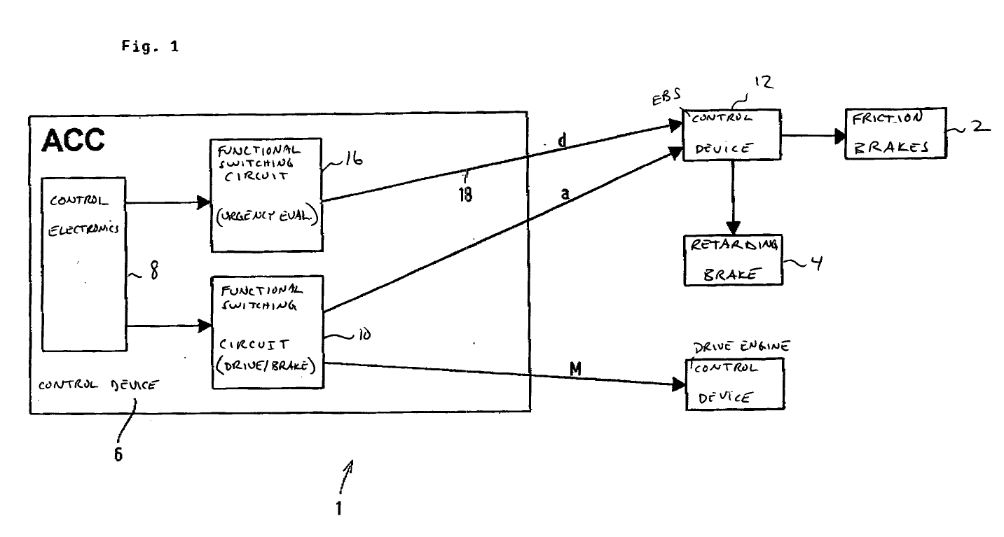

In FIG. 1, a preferred design of a system for controlling the brakes of a commercial vehicle is indicated by reference number 1; the system is equipped with friction brakes 2, for example, in the form of a pneumatic brake, and a retarding brake 4, for example in the form of a retarder.

The system 1 comprises a known device for the adaptive regulation of distance and/or driving speed, hereinafter referred to as an ACC system. This ACC system preferably determines the distance to a vehicle in front of the commercial vehicle, along with additional data, and utilizes these to regulate the time gap between the vehicles, to which end control electronics 8 integrated into a control device 6 of the ACC system is provided. From the acquired values, the time gap to the vehicle traveling in front of the commercial vehicle is calculated, and is compared with a desired time gap, which is input by the driver. If the time gap should fall below the desired time gap, the ACC system reacts in accordance with the driving situation by reducing engine torque and, if necessary, automatically applying the brakes. To this end, the control electronics 8 communicate with a functional switching circuit, “allocation of drive/brake” 10, of the control device 6, which sends control signals “a” and “M” to a control device 12 of an electronically regulated brake system, hereinafter referred to as EBS, and to a control device 14 of a drive engine of the commercial vehicle. Furthermore, the control electronics 8 of the control device 6 communicate with a functional switching circuit “evaluation of urgency” 16, which modulates an urgency signal “d” that is based upon a hazard variable, such as the relative speed of and/or distance to a vehicle traveling in front of said vehicle.

The control device 12 of the EBS is designed to distribute an amount of braking force called for by the driver, and/or by the control device 6 of the ACC system, and/or by other control devices to the friction brake 2 and the retarding brake 4, especially in order to generate the desired braking force with the least possible wear and tear on the friction brakes 2. To this end, preferably the very rapid-response pneumatic friction brakes 2 are applied only at the start of the initiation of braking, and are then replaced by the delayed braking force of the retarding brake 4. Thus, the distribution of braking forces to the friction or retarding brake 2, 4 is first only time-dependent.

According to the invention, the control device 12 of the EBS is further designed in such a way that the distribution of the required braking force to the friction brake 2 and the retarding brake 4 is further based upon the urgency signal d. To this end, the urgency signal d generated by the functional switching circuit “evaluation of urgency” 16 of the control device 6 of the ACC system is preferably supplied to the control device 12 of the EBS via a CAN data bus, whereupon the EBS initiates an application of braking force that corresponds with the urgency signal d, and sends corresponding control signals to the friction brakes 2 and to the retarding brake 4.

The urgency signal d is a signal based, for example, upon the SAE J1939 Standard, wherein a value range of between 0% indicating no urgency and 100% indicating the greatest urgency is provided. According to a particularly preferred braking strategy, at high urgency values the desired braking force is distributed to the friction brakes 2 and the retarding brake 4 in order to achieve the fastest possible application of the brakes, while at low urgency values the retarding brake 4 is maximally utilized, in order to keep wear and tear on the friction brakes 2 as low as possible.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### Table of Reference Figures

1 System

2 Friction Brake

4 Retarding Brake

6 ACC Control Device

8 ACC Control Electronics

10 Functional Switching Circuit (DRIVE/BRAKE)

12 EBS Control Device

14 Engine Control Device

16 Functional Switching Circuit (URGENCY EVALUATION)

18 CAN Data Bus

What is claimed is:

1. A system for controlling brakes of a commercial vehicle, comprising:
at least one of an adaptive distance regulation and driving speed device which modulates an urgency signal based upon a hazard variable;
an electronically controlled brake system designed to distribute a desired amount of braking force to a friction brake system and a retarding brake; and
wherein the electronically controlled brake system distributes the desired amount of braking force to the friction brake system and the retarding brake based upon the urgency signal.

2. The system according to claim 1, wherein the hazard variable is at least one of a relative speed and distance to a vehicle traveling in front of the commercial vehicle.

3. The system according to claim 1, wherein a value range of between 0% indicating no urgency and 100% indicating a greatest urgency is provided for the urgency signal.

4. The system according to claim 2, wherein a value range of between 0% indicating no urgency and 100% indicating a greatest urgency is provided for the urgency signal.

5. The system according to claim 3, wherein the electronically controlled brake system includes a control device such that at high urgency values the desired amount of braking force is distributed to the friction brake system and the retarding brake in order to achieve a fastest possible application of the brakes, while at low urgency values the retarding brake is maximally utilized in order to reduce wear and tear on the friction brake system.

6. The system according to claim 4, wherein the electronically controlled brake system includes a control device such that at high urgency values the desired amount of braking force is distributed to the friction brake system and the retarding brake in order to achieve a fastest possible application of the brakes, while at low urgency values the retarding brake is maximally utilized in order to reduce wear and tear on the friction brake system.

7. The system according to claim 5, wherein a CAN data bus transmits the urgency signal from a further control device in said at least one adaptive distance regulation and driving speed device to the electronically controlled brake system control device.

8. The system according to claim 6, wherein a CAN data bus transmits the urgency signal from a further control device in said at least one adaptive distance regulation and driving speed device to the electronically controlled brake system control device.

9. A method for controlling brakes of a commercial vehicle, the method comprising the acts of:
modulating an urgency signal based upon a hazard variable via at least one of an adaptive distance regulation and driving speed device;
distributing a desired amount of braking force to a friction brake system and a retarding brake as a function of the urgency signal using an electronically control brake system.

10. The method according to claim 9, wherein the urgency signal has a value of 0% that indicates no urgency and 100% that indicates a greatest urgency.

11. The method according to claim 9, wherein the act of distributing the desired amount of braking force further comprises the act of distributing at high urgency values the desired amount of braking force to the friction brake system and the retarding brake in order to achieve a fastest possible application of the brakes, while at low urgency values the distribution maximally utilizes the retarding brake in order to reduce wear and tear on the friction brake system.
